(19) United States
(12) Patent Application Publication
(10) Pub. No.: US 2011/0074764 A1
(43) Pub. Date: Mar. 31, 2011

(54) LIQUID-CRYSTAL DRIVING METHOD AND DEVICE

(75) Inventors: Tomohisa SHINGAI, Kawasaki (JP); Masaki NOSE, Kawasaki (JP)

(73) Assignee: FUJITSU LIMITED, Kawasaki-shi (JP)

(21) Appl. No.: 12/960,727

(22) Filed: Dec. 6, 2010

(30) Foreign Application Priority Data
Aug. 12, 2009 (JP) 2009-278606

(51) Int. Cl. G09G 3/36; G09G 5/00

(52) U.S. Cl. 345/212; 345/87

(57) ABSTRACT

A liquid-crystal driving method includes: setting a reset line, a writing line, and a non-select line in a direction parallel to a plurality of common electrodes, the plurality of the common electrodes and a plurality of segment electrodes being arranged in a matrix form; dividing a driving period into a reset period and a write period; applying a first voltage during the reset period spanning n lines before writing data into the writing line by one of the plurality segment electrodes during the write period, where n is a positive integer; applying a second voltage during the reset period spanning m lines and the write period, where m is a positive integer; and driving a liquid-crystal pixel provided at each intersection of the common electrodes and the segment electrodes.

### CROSS-REFERENCE TO RELATED APPLICATIONS

This application claims the benefit of priority from Japanese Patent Application No. 2009-278606 filed on Dec. 8, 2009, the entire contents of which are incorporated herein by reference.

### FIELD

Embodiments discussed herein relate to a liquid-crystal driving method.

### DESCRIPTION OF RELATED ART

A cholesteric liquid crystal may be used as a method of displaying electronic paper. The cholesteric liquid crystal retains displayed data semi-permanently, and is notable for its vivid color display, high contrast, or high resolution.

Related art is disclosed in Japanese Laid-open Patent Publication No. 2008-33338.

### SUMMARY

According to one aspect of the embodiments, a liquid-crystal driving method includes: setting a reset line, a writing line, and a non-select line in a direction parallel to a plurality of common electrodes, the plurality of the common electrodes and a plurality of segment electrodes being arranged in a matrix form; dividing a driving period into a reset period and a write period; applying a first voltage during the reset period spanning n lines before writing data into the writing line by one of the plurality of segment electrodes during the write period, where n is a positive integer; applying a second voltage during the reset period spanning m lines and the write period, where m is a positive integer; and driving a liquid-crystal pixel provided at each intersection of the common electrodes and the segment electrodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A illustrates an exemplary state of a cholesteric liquid crystal;

FIG. 1B illustrates an exemplary state of a cholesteric liquid crystal;

FIG. 2 illustrates an exemplary image screen of a display element;

FIG. 3 illustrates an exemplary driving waveform;

FIG. 4 illustrates an exemplary liquid-crystal driving circuit;

FIG. 5 illustrates an exemplary liquid-crystal panel;

FIGS. 6A, 6B and 6C illustrate an exemplary relationship between an voltage and a reflectivity;

FIG. 7 illustrates an exemplary planar state;

FIGS. 8A, 8B and 8C illustrate an exemplary voltage waveform;

FIGS. 9A and 9B illustrate an exemplary driving waveform;

FIGS. 10A, 10B, 10C and 10D illustrate an exemplary driving waveform;

FIGS. 11A, 11B, 11C and 11D illustrate an exemplary driving waveform; and

FIG. 12 illustrates exemplary white saturation, exemplary black saturation, and exemplary writing power.

### DESCRIPTION OF EMBODIMENTS

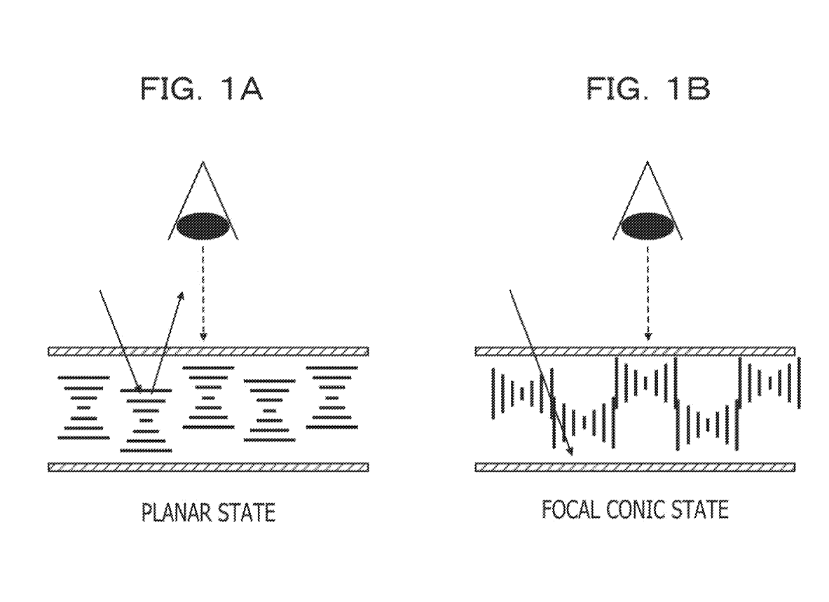

According to one aspect of the embodiments, several tens of percent of a chiral additive such as a chiral material is added to a nematic liquid crystal so that a helical cholesteric phase is formed in a molecule of the nematic liquid crystal and cholesteric liquid crystal is generated. The data display is controlled based on the orientation of each of cholesteric liquid crystal molecules in the cholesteric liquid crystal. Each of FIGS. 1A and 1B illustrates an exemplary state of a cholesteric liquid crystal. FIG. 1A illustrates a planar state where incident light is reflected by the cholesteric liquid crystal. FIG. 1B illustrates a focal conic state where incident light passes through the cholesteric liquid crystal.

In the planar state, as illustrated in FIG. 1A, light with the waveform corresponding to the helical pitch of the liquid crystal molecule is reflected. The helical pitch may be the length of a single rotation performed by a liquid crystal molecule in the planar state. A waveform 2, observed when the reflection is maximized may be illustrated by the following equation, where the average refractive index of the liquid crystal is n and the helical pitch is p;

λ=n·p.

A light absorption layer is provided aside from a liquid crystal layer. When the cholesteric liquid crystal is in the focal conic state illustrated in FIG. 1B, a black color is displayed.

For example, when a strong electric field is applied to the liquid crystal in the planar state or the focal conic state, the helical structure of the liquid crystal molecule is dissolved and the liquid crystal enters the homeotropic state where the liquid crystal molecule is oriented in the direction of the electric field. When the electric field is set to zero in the homeotropic state of the cholesteric liquid crystal, the helical axis of the liquid crystal becomes perpendicular to an electrode so that the liquid crystal enters the planar state where the light corresponding to the helical pitch is selectively reflected.

When an electric field which is so weak that the helical structure of the liquid crystal molecule is not dissolved is formed, and then is eliminated or when a strong electric field is formed, and then is slowly eliminated, the helical axis of the liquid crystal becomes parallel to the electrode and the liquid crystal enters the focal conic state where incident light passes through the liquid crystal. When an intermediate electric field is formed, and then is abruptly eliminated, the planar state and the focal conic state coexist and gradation image data is displayed.

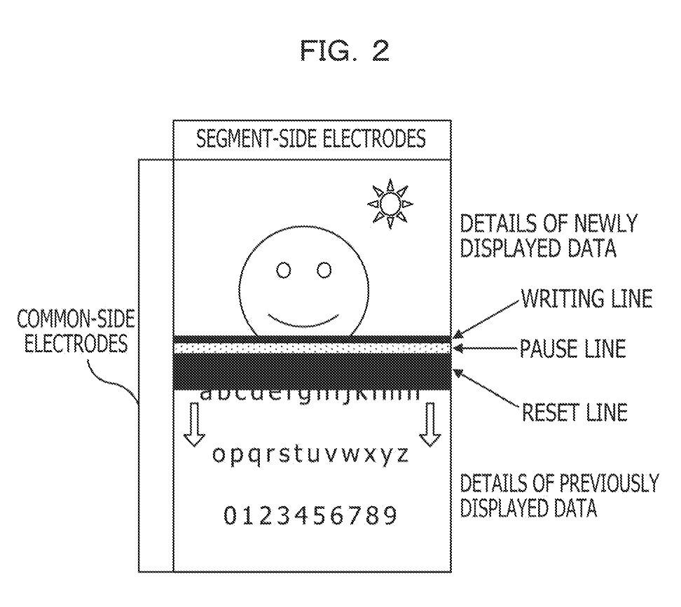

FIG. 2 illustrates an exemplary screen image of a display element. A reset period and a non-select period are provided before a write period. For example, several to several tens of lines are sequentially selected as reset lines, and the same voltage as that applied to a writing line is applied to each pixel provided on each of the selected lines. A voltage applied to an unselected pixel, which is not scanned, may be applied to a non-select line. FIG. 2 illustrates a state where the writing line (writing top line) reaches an area around a center of the image screen. The lower half of the image screen may illustrate previously displayed data and the upper half of the image screen may illustrate newly displayed data.

The number of segment-side electrodes may be 240 and the number of common-side electrodes may be 320. A display panel having 240×320 pixels may be provided, where the 240 pixels are provided in a horizontal direction and the 320 pixels are provided in a vertical direction. The writing line may be the 170th line as counted from the top of the screen image, the non-select-line number may be 1, and the reset-line number may be 6. The location of the reset line may fall within the range of from the 172nd line to the 177th line as counted from the top of the screen image, and a period of a driving-pulse signal may be 10 milliseconds (ms). It may take 3.2 seconds (s) to drive the entire display panel including 320 lines.

A voltage of 36V/0V, which is used in a white pixel, is applied to the segment-side electrodes, and a voltage of 24V/12V, which is used in a black pixel, is applied to the segment-side electrodes. A voltage of 0V/36V is applied to the common-side electrodes of the selected line and a voltage of 30V/6V is applied to the common-side electrodes of an unselected line. A voltage of ±6V is applied to pixels on the unselected line.

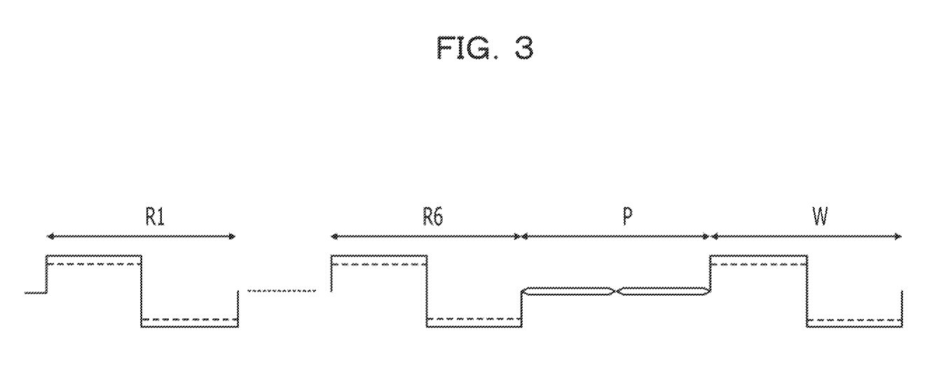

FIG. 3 illustrates an exemplary driving waveform. The driving waveform illustrated in FIG. 3 may be a driving waveform of a cholesteric liquid crystal. A voltage is applied to the reset line and the writing line at the time illustrated in FIG. 3. Each of the signs R1 to R6 denotes a reset period, the sign P denotes a non-select period, and the sign W denotes a write period.

When the 1st to 162nd lines are the writing lines, the 170th line may be an unselected state and a voltage of ±6V is applied to the 170th line. When the 163rd line is the writing line, the 170th line enters a selected state and the voltage corresponding to the pixel value is applied to the 170th line. When the 164th to 168th lines are the writing lines, the 170th line is in the selected state and the voltage corresponding to the pixel value of each of the 164th to 168th lines is applied.

When the 169th line is the writing line, the 170th line is in the unselected state and a voltage of ±6V is applied to the 170th line. When the 170th line is the writing line, the voltage corresponding to the pixel value is applied to the 170th line.

When the 170th line is the writing line, the voltage may be applied to the 170th line six times in advance based on a white pixel or a black pixel.

When the pixels of the 163rd to 168th lines are black and the pixels of the 170th line are white, the brightness is insufficient so that the tailing phenomenon may occur. When the pixels of the 163rd to 168th lines are white and the pixels of the 170th line are black, the darkness is insufficient so that the bright-black-display phenomenon may occur.

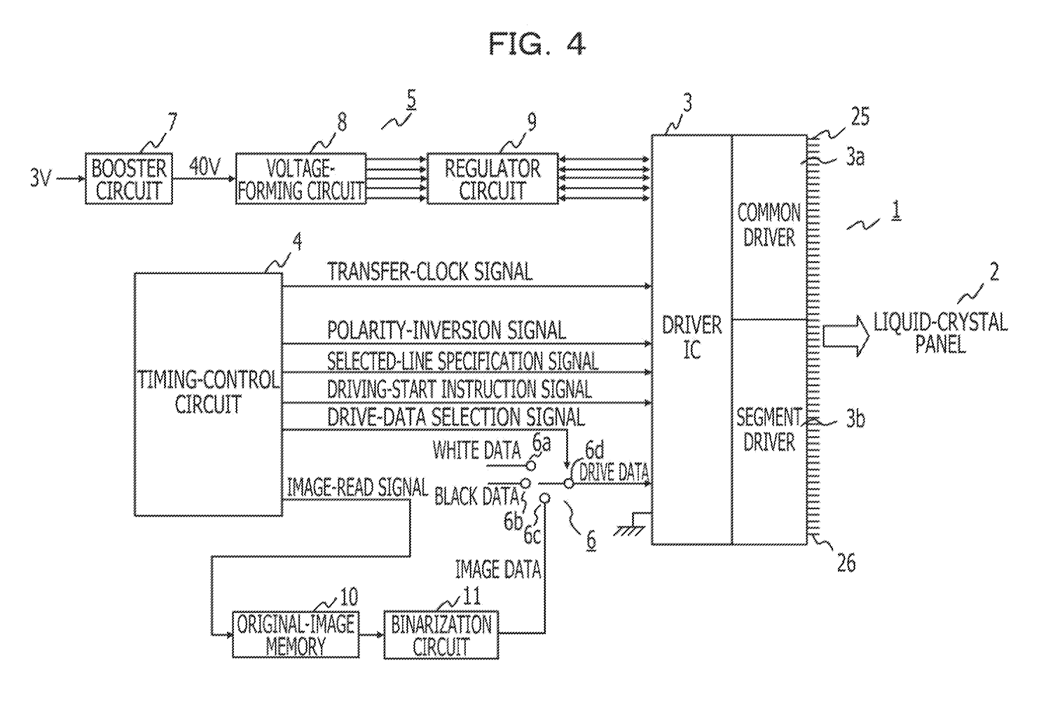

FIG. 4 illustrates an exemplary liquid-crystal driving circuit.

The liquid-crystal driving circuit 1 includes a liquid-crystal panel 2, a driver integrated circuit (IC) 3 dynamically driving a liquid-crystal pixel, a timing-control circuit 4 supplying various control signals to the driver IC 3, a power circuit 5 supplying power to the driver IC 3, and a switching circuit 6. The driver IC 3 includes a common driver 3a and a segment driver 3b. A plurality of common electrodes 25 is arranged from the common driver 3a toward the display panel 2, and a plurality of segment electrodes 26 is arranged from the segment driver 3b toward the display panel 2. The common electrodes 25 and the segment electrodes 26 are arranged in a matrix form and a pixel is provided at an intersection of the common electrode 25 and the segment electrode 26. The common electrode 25 and the segment electrode 26 may dynamically drive the display panel 2.

The power circuit 5 includes a booster circuit 7, a voltage-forming circuit 8, and a regulator circuit 9. The booster circuit 7 boosts an input voltage of 3V to a voltage of 40V, for example. The voltage-forming circuit 8 generates a reference voltage of 40V/28V/12V/34V/6V, for example, based on the boosted voltage by the booster circuit 7, and supplies the reference voltage to the driver IC 3 via the regulator 9. A frequency-division signal obtained by frequency-dividing a reference clock signal is supplied from a clock-generation circuit (not shown) to the timing-control circuit 4, and a write period W or a reset period R may be set based on the frequency-division signal.

The timing-control circuit 4 generates various signals to be supplied to the driver IC 3. The timing-control circuit 4 generates and outputs a transfer-clock signal, a polarity-inversion signal, a selected-line specification signal, or a driving-start instruction signal that are illustrated in FIG. 4 to the driver IC 3. The timing-control circuit 4 generates and outputs a drive-data selection signal to the switching signal 6.

The switching circuit 6 includes a white-data terminal 6a, a black-data terminal 6b, an image-data terminal 6c, and an output terminal 6d, couples the output terminal 6d to one of the terminals based on the drive-data selection signal, and supplies white data, black data, or image data to the segment driver of the driver IC 3.

An original-image memory 10 stores image data. The image data is read based on an image-read signal from the timing-control circuit 4, and is output to the switching circuit 6 via a binarization circuit 11. When the image-data terminal 6c is selected based on the drive-data selection signal, the image data is supplied to the segment driver of the driver IC 3.

Each of the lines of the display panel 2 having 240×320 pixels is driven based on the driving-start instruction signal which is output to the driver IC 3. The polarity of a drive voltage from the driver IC 3 to the liquid-crystal panel 2 is switched based on the polarity-inversion signal. A transfer-clock signal may be a synchronization signal for transferring the image data, the white data, or the black data to the segment driver of the driver IC 3, and the image data or the like is supplied to the segment driver in synchronization with the transfer-clock signal.

The image data or the like is serially supplied to the segment driver. When the data corresponding to a single line is supplied to the segment driver, the data is latched by a latch circuit (not shown) in synchronization with the output of the selected-line specification signal, and is used to display data on the liquid-crystal panel 2.

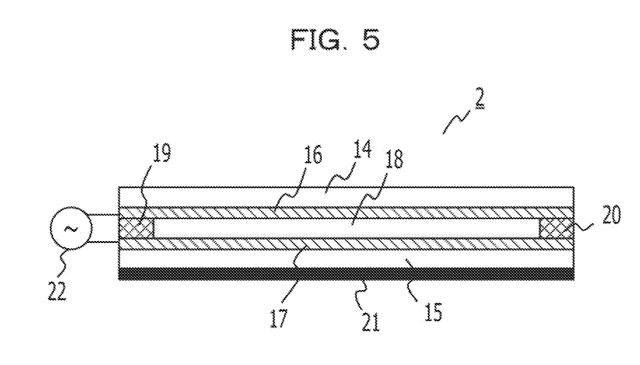

FIG. 5 illustrates an exemplary liquid-crystal panel. FIG. 5 may be a cross-section of the liquid-crystal panel. The liquid-crystal panel 2 includes translucent film substrates 14 and 15, indium-tin oxide (ITO) electrodes 16 and 17, a liquid-crystal mixture 18, sealing compounds 19 and 20 sealing the liquid-crystal mixture 18, and an absorbing layer 21. A driving circuit 22 is coupled to each of the ITO electrodes 16 and 17, and a pulse-like driving signal (driving voltage) is supplied from the driving circuit 22 to the ITO electrodes 16 and 17.

The ITO electrodes 16 and 17 may be arranged so that the ITO electrodes 16 and 17 are opposed to each other when being viewed from a direction perpendicular to the film substrates 14 and 15. The absorbing layer 21 is provided on the back face of the film substrate 15, where the back face is opposite to the light-incident side of the film substrate 15.

Each of the film substrates 14 and 15 may include a film substrate including polyethylene terephthalate (PET), polycarbonate (PC), etc. Each of the film substrates 14 and 15 may include a glass substrate.

The liquid-crystal mixture 18 may be a cholesteric liquid crystal composition showing a cholesteric phase at ambient temperatures. The liquid-crystal mixture 18 may be, for example, a cholesteric liquid crystal including a nematic liquid crystal mixture added 10 to 40 weight percent of a chiral material. The amount of the added chiral material may be determined when the total amount of a nematic liquid crystal component and the chiral material is 100 weight percent.

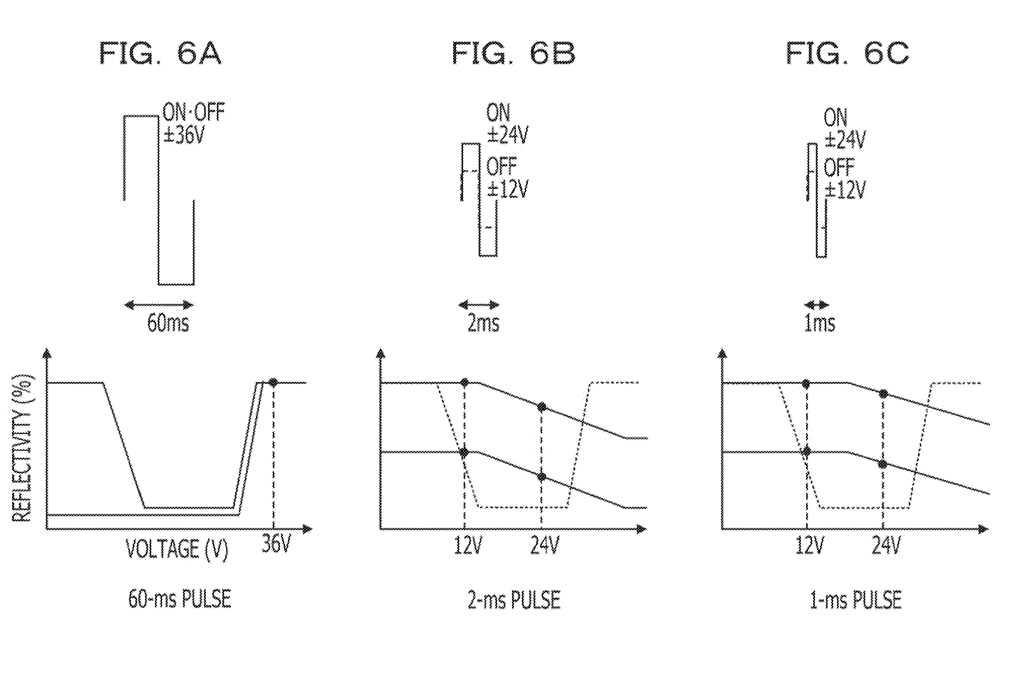

FIGS. 6A, 6B, and 6C illustrate an exemplary relationship between an applied voltage and a reflectivity. FIG. 6A illustrates response characteristics of a cholesteric liquid crystal when a driving pulse with a pulse width of 60 ms is applied to the cholesteric liquid crystal. FIG. 6B illustrates response characteristics of the cholesteric liquid crystal when a driving pulse with a pulse width of 2 ms is applied to the cholesteric liquid crystal. FIG. 6C illustrates response characteristics of the cholesteric liquid crystal when a driving pulse with a pulse width of 1 ms is applied to the cholesteric liquid crystal. For example, when the initial state of the cholesteric liquid crystal is the planar state and the value of a pulse voltage of 60 ms is increased to a certain range as illustrated in FIG. 6A, the cholesteric liquid crystal enters the drive band corresponding to the focal conic state. When the pulse voltage is further increased, the cholesteric liquid crystal returns to the drive band corresponding to the planar state. When the initial state is the focal conic state, the cholesteric liquid crystal enters the drive band corresponding to the planar state with an increase in the pulse voltage. The voltage provided when the initial state is shifted to the planar state may be a voltage of ±36 volts, for example.

When a voltage is low or a pulse voltage with a short period is applied to the cholesteric liquid crystal, as illustrated in FIGS. 6B and 6C, the response characteristics of the cholesteric liquid crystal may be shifted to the high voltage side. For example, when an on-voltage and an off-voltage are set respectively to voltages of ±24 volts and ±12 volts, driving voltages with pulse periods of 2 milliseconds and 1 millisecond are applied to the cholesteric liquid crystal, and the initial state of the cholesteric liquid crystal is the planar state, the response characteristics may not appear when the voltage of ±12 volts is provided for the pulse period of 2 milliseconds (ms), which is illustrated in FIG. 6B, and the pulse period of 1 millisecond (ms), which is illustrated in FIG. 6C, so that the planar state is maintained. When the voltage of ±24 volts is provided, the response characteristics appears for the pulse periods of 2 ms and 1 ms, and gradation image data with decreased reflectivity may be displayed. The decrease in the reflectivity for the pulse period of 2 ms may be more significant than that for that of 1 ms. The pulse period of 2 ms may correspond to a low gradation.

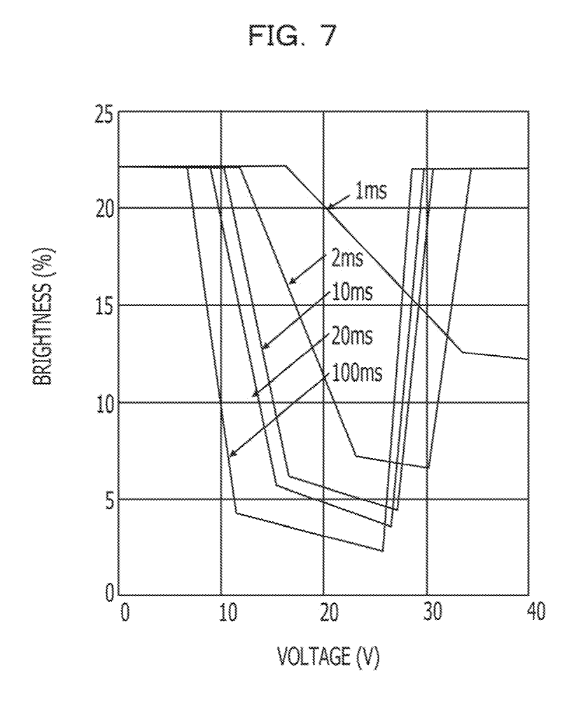

FIG. 7 illustrates an exemplary planar state. For example, as illustrated in FIG. 7, the response characteristics when the period of a pulse voltage applied to the cholesteric liquid crystal is each of 1 ms, 2 ms, 10 ms, 20 ms, and/or 100 ms and the initial state is the planar state are illustrated as the relationship between the applied voltage and the reflectivity. When the same voltage is applied to the cholesteric liquid crystal, a change in the state may be shifted to the high-voltage side as the period of the voltage application decreases. When the period of the pulse-voltage application is 100 ms, the state of the cholesteric liquid crystal is shifted from the planar state to the focal conic state, and is further shifted from the focal conic state to the planar state on the low-voltage side. As the period of the voltage application is gradually reduced from 20 ms, 10 ms, 2 ms, to 1 ms, the change in the state of the cholesteric liquid crystal is shifted to the high-voltage side.

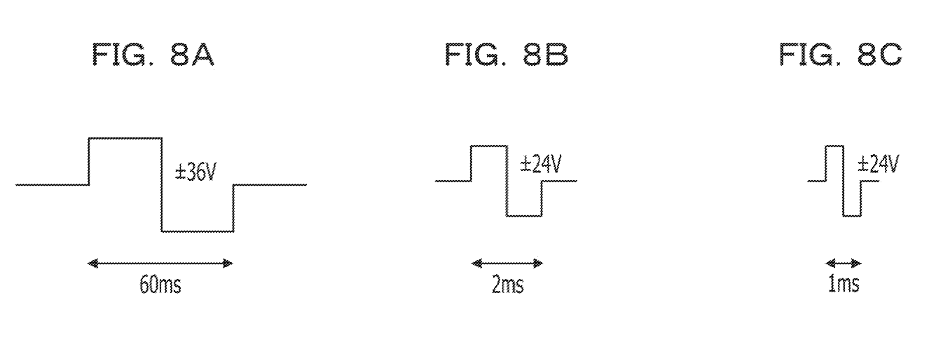

FIGS. 8A, 8B, and 8C illustrate an exemplary voltage waveform. The voltage waveform illustrated in FIGS. 8A, 8B, and 8C may be that of a liquid-crystal cell (liquid-crystal pixel) when a driving voltage is applied to the driver IC 3 (the common driver and the segment driver). FIG. 8A illustrates a waveform when a voltage of ±36 volts having a pulse period of 60 ms is applied to the driver IC 3. FIG. 8B illustrates a waveform when a voltage of ±24 volts having a pulse period of 2 ms is applied to the driver IC 3. FIG. 8C illustrates a waveform when a voltage of ±24 volts having a pulse period of 1 ms is applied to the driver IC 3.

The liquid-crystal panel 2 may have 240×320 pixels, where the 240 pixels are provided in a horizontal direction and the 320 pixels are provided in a vertical direction. The number of electrodes on the segment-side may be 240, and the number of electrodes on the common-side may be 320. The location of the writing line may be the 170th line as counted from the top of the screen image, the number m of a non-select line, which is set as an unselected line, may be 1, and the number n of at least a reset line, for which a reset period R is set, may be 60. The reset line corresponding to the 170th writing line may correspond to the 172nd to 231st lines as counted from the top of the screen image. A write period W denotes the period when image data is written on the reset line and the writing line. The reset period R may be a voltage-application period when a voltage is applied to the reset line so as to change the liquid-crystal state of the liquid-crystal pixel.

A voltage of 40V/0V is applied to the segment-side electrode when the pixel of the selected line is a white pixel, and a voltage of 28V/12V is applied to the segment-side electrode when the pixel of the selected line is a black pixel. A voltage of 0V/40V is applied to the common-side electrode of the selected line and a voltage of 34V/6V is applied to the common-side electrode of the unselected line.

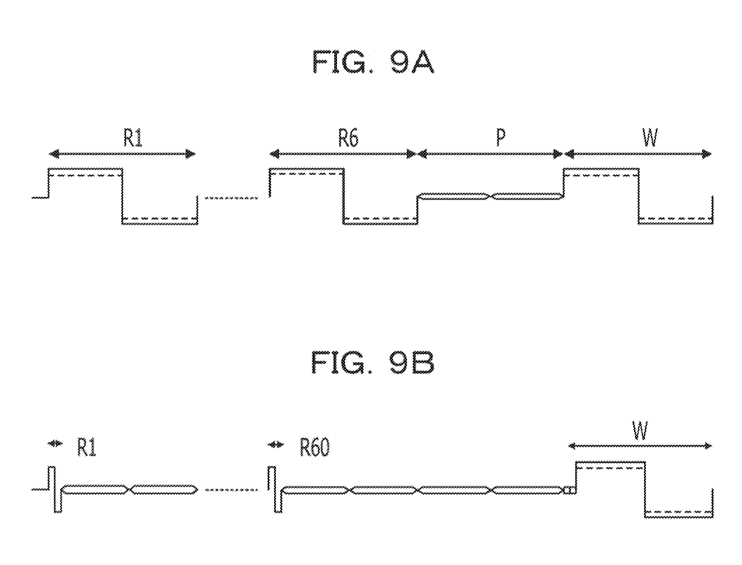

FIGS. 9A and 9B illustrate an exemplary driving waveform.

When the 1st to 108th lines are the writing lines, the 170th line is in the unselected state and a voltage of ±6 volts is applied to the pixel of the 170th line. When the 109th line is the writing line, the voltage corresponding to a black pixel is applied to the 170th line for the first 1 ms, and a voltage of ±6 volts is applied for subsequent 9 ms. When each of the 110th to 168th lines is the writing line, the voltage corresponding to a black pixel is applied to the 170th line for the first 1 ms of, and a voltage of ±6 volts is applied for subsequent 9 ms.

When the 169th line is the writing line, the 170th line is in the unselected state and a voltage of ±6 volts is applied to the pixel of the 170th line. When the 170th line is the writing line, the 170th line is in the unselected state for the first 1 ms and a voltage of ±6 volts is applied to the pixel of the 170th line. For subsequent 9 ms, the 170^{th} line is in the selected state, and the voltage corresponding to the pixels of the 170th line is applied.

The voltage corresponding to a black pixel may be applied to a group of pixels of the 170th line sixty times for the first 1 ms when the data is written in the 109th to 168th lines before the data is written in the 170th line. The state of the pixel of the corresponding 170th line at the writing may correspond to the state where a voltage of 12V to 26V is applied in a pulse period of 60 ms. Consequently, an appropriate black color may be displayed. When the pixel value corresponds to white, a driving voltage of, for example, 40V is applied considering the state where a voltage of 12V to 26V is applied in the pulse period of 60 ms so that an appropriate white color may be displayed. Since the charge and discharge of a voltage of 28V are performed twice within 1 ms, the peak power during the band forming may be high.

For example, the timing-control circuit 4 illustrated in FIG. 4, within the first 1 ms of the driving pulse period, specifies the selected line or the unselected line, changes the value of drive data to 0 indicating, for example, black and transfers the changed drive data, and gives an instruction to start driving the pixels or perform polarity-inversion. The timing-control circuit 4, within subsequent 9 ms of the driving pulse period, specifies the selected line or the unselected line, changes the drive data into binarized image data and transfers the changed drive data, and gives the instruction to start driving the pixels or perform the polarity-inversion.

The drive data may be changed based on the drive-data selection signal. For example, the switching circuit 6 couples the black-data terminal 6b to the input terminal 6d, and supplies black data to the segment driver within a period of the first 1 ms of the driving pulse period. The switching circuit 6 couples the image-data terminal 6c to the input terminal 6d and supplies the image data to the segment driver within subsequent 9 ms of the driving pulse period.

When the white color is displayed after the black color is successively displayed, the tailing phenomenon may not occur. When the black color is displayed after the white color is successively displayed, the bright-black-display phenomenon may not occur.

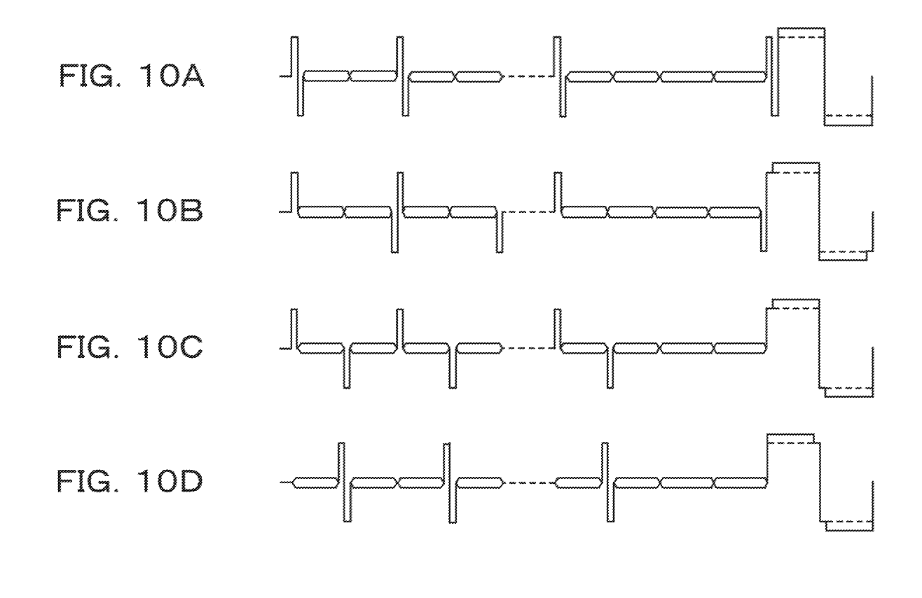

FIGS. 10A, 10B, 10C and 10D illustrate an exemplary driving waveform. The driving waveform illustrated in each of FIGS. 10A and 10B may be the driving waveform of the liquid-crystal driving circuit 1 illustrated in FIG. 4.

In FIGS. 10A to 10D, the first 1 ms of the writing line is set to the selected line. For example, the first 1 ms of the writing line illustrated in FIG. 10A may be set to the selected line.

Since the time of driving with the voltage corresponding to a black pixel increases, the black waveform becomes better than a basic waveform and a white waveform may be inferior to the basic waveform. Since the charge and discharge of a voltage of 28V are performed twice within 1 ms, the peak power at the band forming may be high.

For example, the timing-control circuit 4 illustrated in FIG. 4 outputs the transfer-clock signal, the polarity-inversion signal, the selected-line specification signal, or the driving-start instruction signal to the driver IC 3 so that the selected line or the like is switched. The switching circuit 6 selects the black data or the image data based on the drive-data selection signal from the timing-control circuit 4, and outputs the selected data to the driver IC 3.

In FIG. 10B, the reset-line selection period is set to the first 0.5 ms and the last 0.5 ms, and the band of the writing line is formed on the selected line. On each of the reset lines including the 109th to 168th lines, the voltage corresponding to a black pixel is applied to the first 0.5 ms and the last 0.5 ms, and a voltage of ±6V is applied for the former 4.5 ms and the latter 4.5 ms. The band of the writing line is formed on the selected line.

Since the time period of driving with the voltage corresponding to a black pixel increases, the waveform corresponding to the black color becomes better than the basic waveform. However, the waveform corresponding to the white color may be inferior to the basic waveform. Since the charge and discharge of a voltage of 28V are performed twice within 1 ms, the peak power at the band forming may be high.

In FIG. 10C, the selection period on the reset line is set to 0.5 ms of the beginning of each of the former 5 ms and the latter 5 ms, and the band of the writing line is formed on the selected line.

Since the time period of driving with the voltage corresponding to a black pixel increases, the waveform corresponding to the black color becomes better than the basic waveform. However, the waveform corresponding to the white color may become inferior to the basic waveform. Since the charge and discharge of a voltage of 28V are performed only once within 0.5 ms, the peak power at the band forming may be low.

In FIG. 10D, the selection period on the reset line is set to each of the last 0.5 ms of the first 5 ms and the former 0.5 ms of the latter 5 ms, and the band of the writing line is formed on the selected line.

The time period of driving with the voltage corresponding to a black pixel increases, the waveform corresponding to the black color becomes better than the basic waveform, and the waveform corresponding to the white color may become inferior to the basic waveform. Since the charge and discharge of a voltage of 28V are performed twice within 1 ms, the peak power at the band forming may be high.

A band-forming voltage may be a voltage at the white-pixel write time. The voltage corresponding to a white pixel is applied to the reset lines including the 109th to 168th lines within the first 1 ms. As illustrated in FIG. 7, a voltage of 40V at the white-pixel write time is applied in a pulse period of 1 ms, and a color obtained in that case may become darker than a color obtained when a voltage of 28V at the black-pixel write time is applied.

The switching circuit 6 couples the white-data terminal 6a to the input terminal 6d based on the drive-data selection signal from the timing-control circuit 4, and supplies white data to the segment driver. Image data is selected by coupling image-data terminal 6c to the input terminal 6d.

Although the display of the black color may be improved, the display of the white color may be deteriorated. Since the charge and discharge of a voltage of 40V are performed twice within 1 ms, the peak power at the band forming may be high.

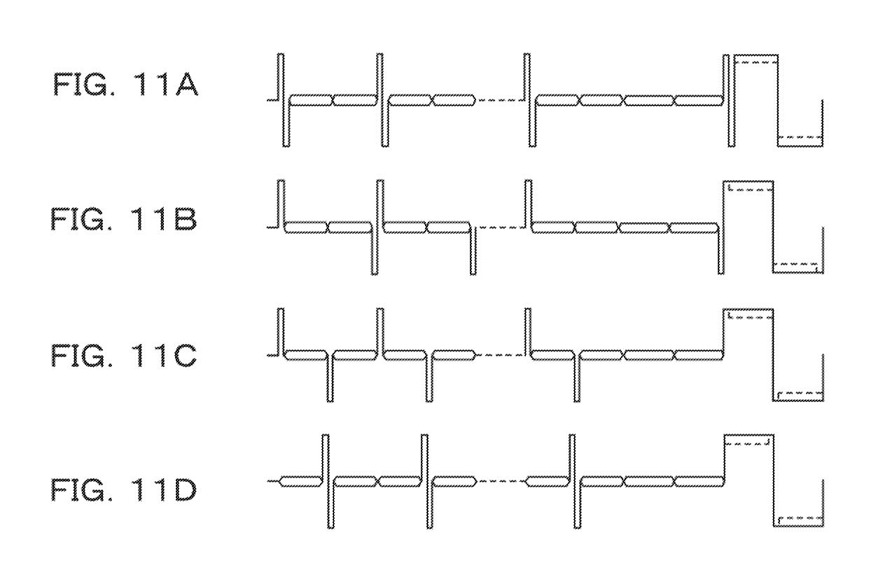

FIG. 11A illustrates an exemplary driving waveform. The driving waveform illustrated in FIG. 11A may be the driving waveform of the liquid-crystal driving circuit 1 illustrated in FIG. 4. The first 1 ms of the writing line is set to the selected line and data applied during the selection period may be white data.

Although the display of the white color may be improved, the display of the black color may be deteriorated. Since the charge and discharge of a voltage of 40V are performed twice within 1 ms, the peak power at the band forming may be high.

FIG. 11B illustrates an exemplary driving waveform. The driving waveform illustrated in FIG. 11B may be the driving waveform of the liquid-crystal driving circuit 1 illustrated in FIG. 4. The voltage corresponding to a white pixel is applied to the reset line including the 109th to 168th lines in each of the first 0.5 ms and the last 0.5 ms, and a voltage of ±6V is applied to the reset line in each of the former remaining 4.5 ms and the latter remaining 4.5 ms.

Although the display of the white color may be improved, the display of the black color may be deteriorated. Since the charge and discharge of a voltage of 40V are performed twice within 1 ms, the peak power at the band forming may be high.

FIG. 11C illustrates an exemplary driving waveform. The driving waveform illustrated in FIG. 11C may be the driving waveform of the liquid-crystal driving circuit 1 illustrated in FIG. 4. The voltage corresponding to a white pixel is applied within 0.5 ms of the beginning of each of the period of the former 5 ms and the period of the latter 5 ms of the reset line.

Although the display of the white color may be improved, that of the black color may be deteriorated. Since the charge and discharge of a voltage of 40V are performed only once within 0.5 ms, the peak power at the band forming may be low.

FIG. 11D illustrates an exemplary driving waveform. The driving waveform illustrated in FIG. 11D may be the driving waveform of the liquid-crystal driving circuit 1 illustrated in FIG. 4. The voltage corresponding to a white pixel is applied in each of the period of the last 0.5 ms of the period of the first 5 ms of the reset-line selection period, and the period of the former 0.5 ms of the period of the latter 5 ms of the reset-line selection period.

Although the display of the white color may be improved, the display of the black color may be deteriorated. Since the charge and discharge of a voltage of 40V are performed twice within 1 ms, the peak power at the band forming may be high.

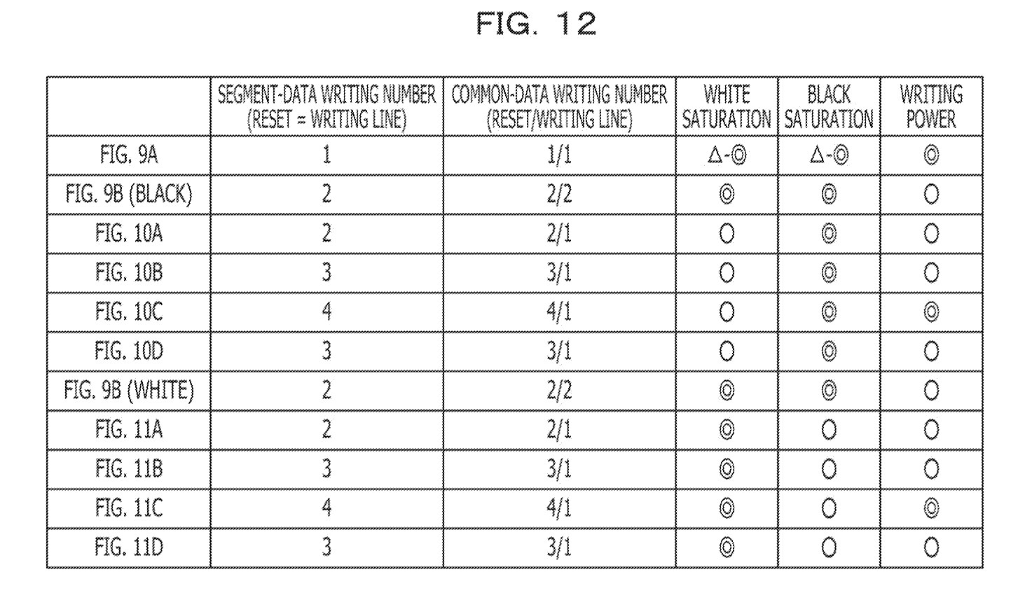

FIG. 12 illustrates exemplary white saturation, exemplary black saturation, and exemplary writing power. In FIG. 12, the sign ⊚ denotes “exceedingly appropriate”, the sign ◯ denotes “appropriate”, and the sign Δ denotes “not appropriate”.

A segment-data writing number denotes the number of writing data into the segment driver. The number of writing data into the segment driver on the reset line may be substantially the same as a number of writing data into the segment driver on the writing line. According to FIG. 9B (black), for example, the segment-data writing number may be two. One is writing black data into the segment driver and the other is writing image data into the segment driver. According to FIG. 10A, the segment-data writing number may be two. One is writing black data into the segment driver and the other is writing image data into the segment driver. According to FIG. 10B, since black data is output in the period of the first 0.5 ms and the period of the last 0.5 ms on the reset line, image data is written into the segment driver once and the black data is written into the segment driver twice. Consequently, the total of the segment-data writing number becomes three.

The number of writing data into the common driver on the reset line may be different from the number of writing data into the common driver on the writing line. For example, when at least one of black data and white data and image data are written into the reset line, the corresponding line such as a narrow band is selected. The number of writing data may be substantially equivalent to the segment-data writing number, and the number of writing data into the writing line may be one.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A liquid-crystal driving method comprising:
setting a reset line, a writing line, and a non-select line in a direction parallel to a plurality of common electrodes, the plurality of the common electrodes and a plurality of segment electrodes being arranged in a matrix form;
dividing a driving period into a reset period and a write period;
applying a first voltage during the reset period spanning n lines before writing data into the writing line by one of the plurality of segment electrodes during the write period, where n is a positive integer;
applying a second voltage during the reset period spanning m lines and the write period, where m is a positive integer; and
driving a liquid-crystal pixel provided at each intersection of the common electrodes and the segment electrodes.

2. The liquid-crystal driving method according to claim 1, wherein a state of a liquid crystal of the liquid-crystal pixel is changed due to the first voltage, and
wherein the state of the liquid crystal of the liquid-crystal pixel is not changed due to the second voltage.

3. The liquid-crystal driving method according to claim 1, further comprising:
shifting at least one of the reset line, the non-select line and the writing line in a direction intersecting one of the plurality of common electrodes; and
supplying image data to be written into the writing line to one of the plurality of segment electrodes.

4. The liquid-crystal driving method according to claim 1,
wherein n is an integer larger than ten.

5. The liquid-crystal driving method according to claim 1,
wherein m is an integer smaller than or equal to two.

6. The liquid-crystal driving method according to claim 1, wherein a ratio of a total time of the write period to a total time of the reset period is about 0.05 to about 0.2.

7. The liquid-crystal driving method according to claim 1, wherein the first voltage includes a write voltage in a transmissive state during the write period.

8. The liquid-crystal driving method according to claim 1, wherein the first voltage includes a write voltage in a reflective state during the write period.

9. The liquid-crystal driving method according to claim 1, wherein the first voltage includes a write voltage in a transmissive state in one or more first lines out of the n lines, and includes a write voltage in a reflective state in one or more second lines out of the n lines.

10. The liquid-crystal driving method according to claim 9, wherein a total number of the one or more first lines and the one or more second lines is n.

11. The liquid-crystal driving method according to claim 1, further comprising:
applying one of the first voltage and the second voltage into the reset line, the writing line or the non-select line during the reset period when writing data.

12. The liquid-crystal driving method according to claim 1, wherein the driving period of the reset line, the writing line or the non-select line includes a first reset period having a half of the reset period, the write period and a second reset period having a different half of the reset period.

13. The liquid-crystal driving method according to claim 1, wherein the driving period of the reset line, the writing line or the non-select line includes a first reset period having a half of the reset period, a first write period having a half of the write period, a second write period having a different half of the reset period, and a second write period having a different half of the write period.

14. The liquid-crystal driving method according to claim 1, wherein the driving period of the reset line, the writing line or the non-select line includes a first write period having a half of the write period, the reset period, and a second write period having a different half of the write period.

15. A liquid-crystal driving device comprising:
common electrodes and segment electrodes that are arranged in a matrix form;
a liquid-crystal pixel provided at each intersection of the common electrodes and the segment electrodes;
a plurality of lines arranged in a direction parallel to the common electrodes;
a division circuit to divide a driving period for driving the plurality of lines into a reset period and a write period;
a first voltage-applying circuit to apply a first voltage during the reset period spanning n lines before writing data onto the lines by the segment electrode during the write period, where n is a positive integer; and
a second voltage-applying circuit to apply a second voltage during the reset period spanning m lines and the write period, where m is a positive integer.

16. The liquid-crystal driving device according to claim 15,
wherein the first voltage includes a voltage that changes a state of a liquid crystal of the liquid-crystal pixel, and
wherein the second voltage includes a voltage that does not change the state of the liquid crystal of the liquid-crystal pixel.

17. The liquid-crystal driving device according to claim 15, wherein the line includes a reset line, a writing line, and a non-select line.
